(19) United States
(12) Patent Application Publication
(10) Pub. No.: US 2025/0347441 A1
(43) Pub. Date: Nov. 13, 2025

(54) CONDENSING BOILER FOR USE WITH NON-CONDENSING STACKS

(71) Applicant: Aerco International, Inc., Blauvelt, NY (US)

(72) Inventors: Kyle T Morgan, Mount Sinai, NY (US); Hakan Bjornson, Morristown, NJ (US); Corey Ditmars, Rochelle Park, NJ (US); Gerald A Fioriti, Rock Tavern, NY (US); Iram Rahman, Medford, NY (US); Adrian Voicu, Bloomfield, NJ (US)

(73) Assignee: Aerco International, Inc., Blauvelt, NY (US)

(21) Appl. No.: 18/657,299

(22) Filed: May 7, 2024

(51) Int. Cl. F24H 1/12; F24H 8/00; F28F 1/08

(52) U.S. Cl. CPC F24H 1/124; F24H 8/00; F28F 1/08

(57) ABSTRACT

A condensing boiler for use with a non-condensing stack, including a heat exchanger with a combination of higher efficiency heat exchanger tubes and lower efficiency heat exchanger tubes.

### FIELD OF THE DISCLOSURE

The present disclosure relates to condensing boilers and water heaters, and particularly to heat exchanger tubes employed in the heat exchangers of condensing boilers and water heaters.

### BACKGROUND

Condensing boilers and water heaters produce a lower temperature and wetter flue gas that requires a relatively expensive stainless-steel stack, exhaust vent, or chimney, that is listed by United Laboratories (“UL”) as Category IV, based on pressure and corrosion resistance. Older boiler stacks that existed before the widespread adoption of condensing boilers and water heaters are usually Category I stacks that are unsuitable for use with a lower temperature and wetter flue gas. As used herein, “condensing stack” refers to a Category IV stack while a “non-condensing stack” refers to a Category I stack. As used herein, a “condensing boiler” means either a condensing boiler or a condensing water heater.

Because of its pressure and corrosion resistance, a condensing stack is more expensive than a non-condensing stack. The replacement of a stack can also be very expensive in terms of labor and parts. So, when an older less efficient non-condensing boiler is replaced with a more efficient condensing boiler, the need to replace the non-condensing stack with a condensing stack can be a large part of the overall costs of the boiler upgrade. Particularly in urban settings where boiler stacks can be very tall and even hundreds of feet high, replacing a non-condensing stack with a condensing stack can cost far more than the new condensing boiler itself. The ability to use a condensing boiler with a non-condensing stack would provide significant savings and encourage and allow the use of more efficient condensing boilers.

### SUMMARY

The present disclosure provides a condensing boiler having a heat exchanger configured to be fluidly coupled to burner, a hot water supply, and a cold water supply. The heat exchanger includes a combination of lower efficiency heat exchanger tubes and higher efficiency heat exchanger tubes.

A combination of higher efficiency heat exchanger tubes and lower efficiency heat exchanger tubes in the boiler heat exchanger has been found to effectively produce a drier and hotter flue gas that can be released into existing non-condensing stacks, without significantly reducing the overall efficiency of the condensing boiler. A condensing boiler in accordance with the present disclosure can therefore be used with previously installed non-condensing stacks, which provides saving to property owners and encourages the use of more efficient condensing boilers. A condensing boiler in accordance with the present disclosure can also allow the use of less expensive non-condensing stacks in new construction.

According to one exemplary embodiment of the present disclosure, the lower efficiency heat exchanger tubes have a smooth sidewall, and the higher efficiency heat exchanger tubes have a corrugated sidewall. According to another embodiment, the higher efficiency heat exchanger tubes have a flattened and crimped sidewall. According to a further embodiment, the lower efficiency heat exchanger tubes have a smaller cross-sectional diameter than the higher efficiency heat exchanger tubes.

According to still another exemplary embodiment of the present disclosure, a ratio between the higher efficiency heat exchanger tubes and the lower efficiency heat exchanger tubes in the heat exchanger is between 1:100 to 1:10. According to an additional embodiment, a ratio between the higher efficiency heat exchanger tubes and the lower efficiency heat exchanger tubes in the heat exchanger is between about 50% and about 99%.

According to another exemplary embodiment of the present disclosure, the higher efficiency heat exchanger tubes are between 5% and 85% more efficient than the lower efficiency heat exchanger tubes. According to a further exemplary embodiment, the higher efficiency heat exchanger tubes are between 25% and 50% more efficient than the lower efficiency heat exchanger tubes.

A method to vent a condensing boiler into a non-condensing stack is also disclosed herein that includes providing a condensing boiler having a heat exchanger containing a mixture of higher efficiency heat exchanger tubes and lower efficiency heat exchanger tubes in the heat exchanger, directing combustion gases into first ends of the heat exchanger tubes, directing water through the heat exchanger and outside of the tubes, and directing flue gas from second ends of the heat exchanger tubes into the non-condensing stack.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 illustrates a condensing boiler according to an exemplary embodiment of the present disclosure shown connected to a stack, wherein the boiler is partially cut-away to reveal its internal parts;

FIG. 2 illustrates a cross-section of a heat exchanger, according to an embodiment, from the condensing boiler of FIG. 1;

FIG. 3 illustrates a bottom plan view of the heat exchanger of FIG. 2 showing a mixture of lower and higher efficiency heat exchanger tubes in accordance with an exemplary embodiment of the present disclosure;

FIG. 4 illustrates ends of the lower and higher efficiency heat exchanger tubes of FIG. 3;

FIG. 5 illustrates a side elevation view of lower efficiency heat exchanger tube, according to an exemplary embodiment;

FIG. 6 illustrates a side elevation view of a higher efficiency heat exchanger tube, according to an exemplary embodiment;

FIG. 7 illustrates a front elevation view of a higher efficiency heat exchanger tube, according to another exemplary embodiment;

FIG. 8 illustrates a sectional view of the higher efficiency heat exchanger tube, taken along line 8--8 of FIG. 7; and

FIG. 9 illustrates an end plan view of the higher efficiency heat exchanger tube of FIG. 7.

### DETAILED DESCRIPTION

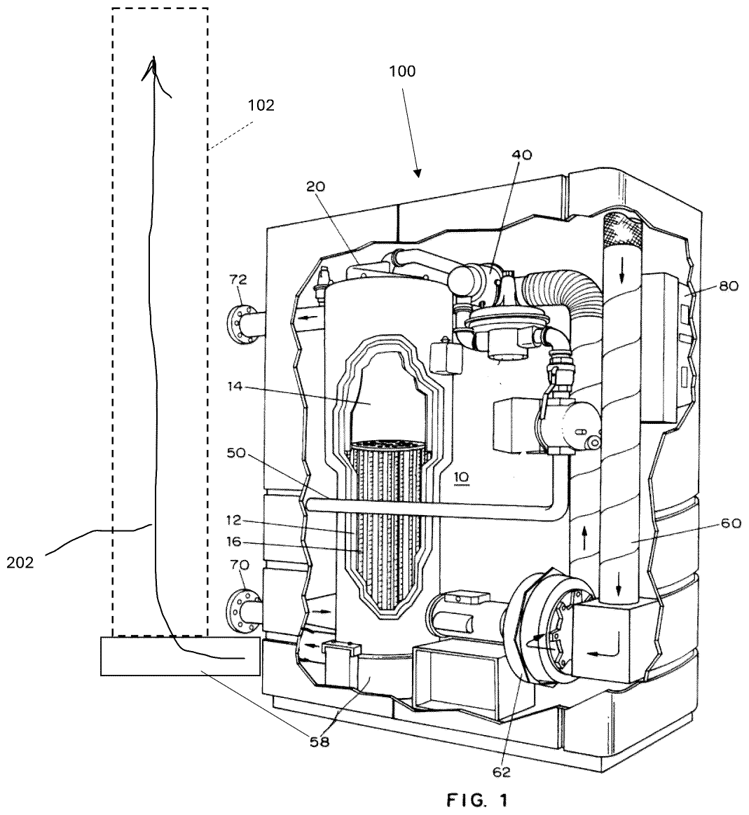

FIG. 1 illustrates a condensing boiler according to an exemplary embodiment of the present disclosure. The boiler 100 includes a heat exchanger 10, a burner 20, an air/fuel valve 40, a gas fuel intake 50, a flue gas exhaust manifold 58, an air intake 60, a water inlet nozzle 70, a water outlet nozzle 72, and a control panel 80.

The heat exchanger 10 provides for heat transfer between a fluid (preferably a hot gas) and a liquid (preferably water) such that as the water travels upwards within the heat exchanger it increases in temperature establishing a temperature gradient in the direction of flow of water. As shown in FIG. 1, the heat exchanger 10 includes a water chamber 12, a combustion chamber 14, and a plurality of heat exchange tubes 16. The water chamber 12 encloses both the combustion chamber 14 and the heat exchange tubes 16. The combustion chamber 14 is located at the upper end of the water chamber 12. The tubes 16 are connected to the bottom of the combustion chamber 14 and extend downwards through the water chamber 12 to the gas exhaust manifold 58.

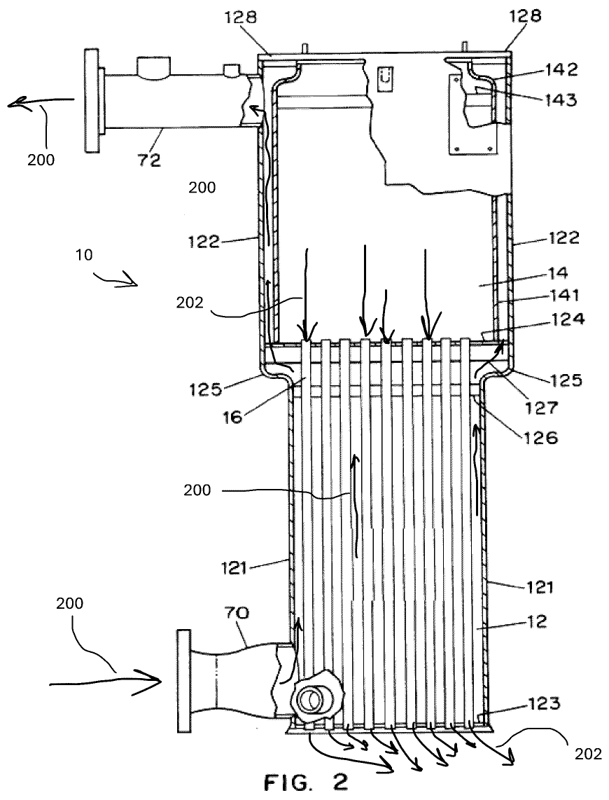

Referring to FIG. 2, in the exemplary embodiment shown, the water chamber 12 consists of a lower shell 121 joined to an upper shell 122 by an expansion joint 125. A backing ring 126 at the lower end of the expansion joint 125 supports the shells 121, 122. The lower shell 121 is connected to the water inlet nozzle 70, and the upper shell 122 is connected to the water outlet nozzle 72.

The water chamber further includes a lower tubesheet 123 and an upper tubesheet 124. These tubesheets are flat disks having a plurality of holes in which the heat exchange tubes 16 fit, with first ends of the tubes 16 being connected to the upper tubesheet 124 and second ends of the tubes being connected to the lower tubesheet 123. In addition, the upper tubesheet contains a circle of holes along its outer edge through which water may flow around the combustion chamber 14. According to one exemplary embodiment, the lower tubesheet 123 and the upper tubesheet 124 are welded at their periphery to the bottoms of the lower shell 121 and the upper shell 122, respectively, and the heat exchange tubes 16 are welded between these two tubesheets 123, 124.

The combustion chamber consists of a cylindrical shell 141 on which an expansion joint 142 is welded at the upper end. In addition, a backing ring 143 is welded to the expansion joint for support. The combustion chamber 14 fits within the upper shell 122 and is welded at its lower end to the upper tubesheet 124. Both the combustion chamber 14 and the upper shell 122 are welded at their upper ends to a flat annulus 128, referred to as the upper head. Although not shown in FIG. 2, the burner extends into the combustion chamber 14 through the annulus 128.

In operation, water, illustrated in FIG. 2 by arrows 200, enters from the water inlet nozzle 70 and travels upwards through the chamber in the lower shell 121, coming into contact with the outsides of the heat exchange tubes 16 as it travels up. When the water reaches the upper tubesheet 124, it passes through the holes along the tubesheet's outer edge into the annular channel created by the upper shell 122 and the combustion chamber shell 141. From this annular channel, the water exits at the water outlet nozzle 72. As the water travels upwards, hot combustion gases, illustrated in FIG. 2 by arrows 202, travel downward through the combustion chamber 14 and to the first ends of the tubes 16. The gases 202 travel through the heat exchange tubes 16 in true counterflow to the water flow 200. The gas 202 exits the second end of the tubes 16 and, also referring to FIG. 1, the gas 202 then passes through the gas exhaust manifold 58 to a connected stack 102. Although not shown, the stack 102 vents the gases 202 to the atmosphere outside a building containing the boiler 100.

It should be noted that, when the gas 202 is in the combustion chamber 14 and within the heat exchanger tubes 16, the gas may be referred to as “combustion gas” and when the gas 202 is in the flue it may be referred to as “flue gas”. The gas 202 may include nitrogen, oxygen, carbon dioxide, and water, with dilute amounts of sulfuric, carbonic, and nitric acid, while the fuel used may be natural gas.

Accordingly, the heat exchanger 10 allows water 200 to travel in physical isolation from, but in heat exchange relation with, the hot gases 202 passing through the combustion chamber 14 and the heat exchange tubes 16. As the water 200 flows upwards in true counterflow to the hot gases 202, heat is transferred to the water, causing a temperature gradient in the direction of the water flow. Conversely, as the gases 202 flow downwards, they are cooled in traversing the heat exchange tubes 16.

The true counterflow movement of the water and gases in the present invention provides for excellent efficiency of operation. As the gases are cooled below their dew point, they condense, providing additional heat to the water through the energy release of condensation. Efficiency levels greater than 90 percent, not possible without the condensing operation, are thus achieved. Moreover, the condensing operation is advantageous because the movement of condensate droplets or film through the heat exchange tubes helps to sweep out any carbon particles that may accumulate in the tubes, thereby maintaining optimal heat transfer.

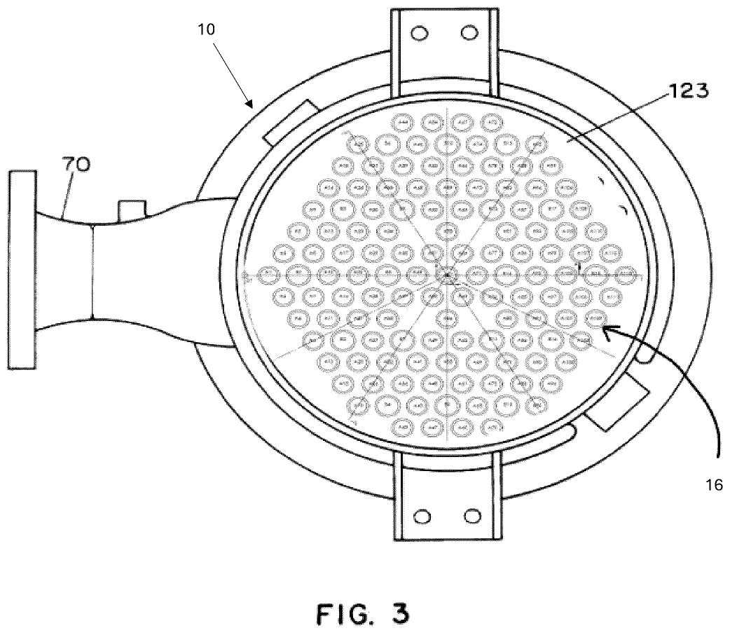

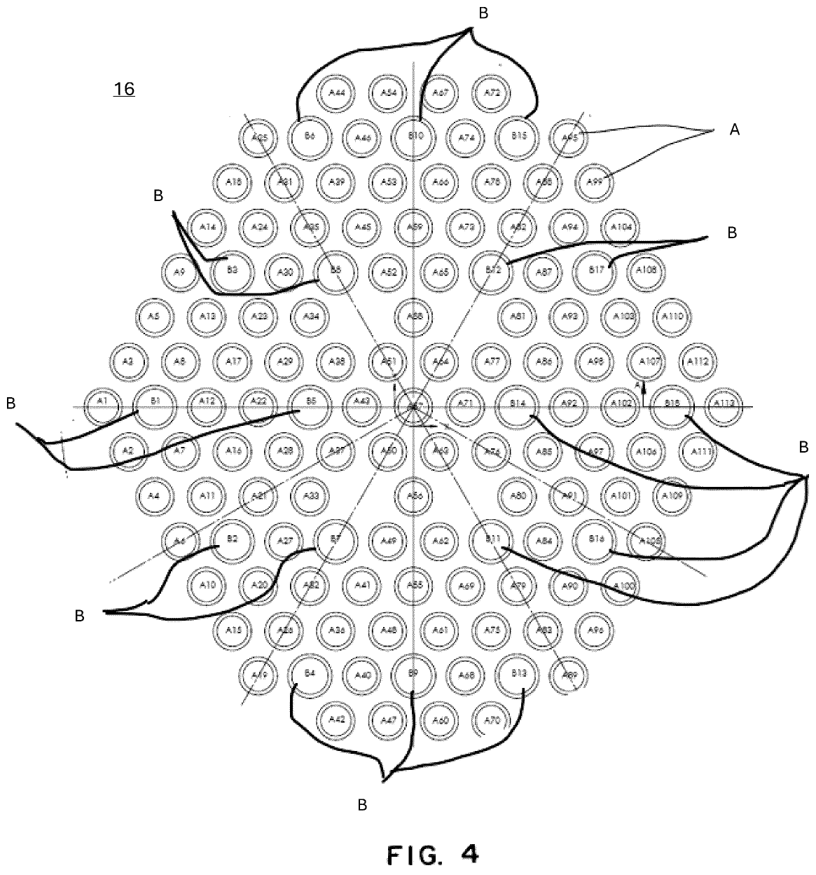

FIG. 3 illustrates a bottom plan view of the heat exchanger 10, according to an exemplary embodiment. As illustrated in FIG. 3, the heat exchanger tubes 16 are arranged in parallel in the heat exchanger 10 and include higher efficiency heat exchanger tubes A and lower efficiency heat exchanger tubes B. FIG. 4 shows just the heat exchanger tubes 16.

The ratio between the higher efficiency heat exchanger tubes A and the lower efficiency heat exchanger tubes B can be between 1:100 to 1:10, between 1:10 to 1:5, between 1:20 to 1:2.

The ratio between the higher efficiency heat exchanger tubes A and the lower efficiency heat exchanger tubes B can be about 50% and about 99%, between about 65% and about 98%, and about 75% and about 95%.

The ratio of the higher efficiency heat exchanger tubes A to lower efficiency heat exchanger tubes B is configured to produce a flue gas at or about 360° F. with reduced levels of vapor compared to conventional condensing boilers.

As used herein “efficiency” means an efficiency of a heat transfer from the combustion gases 202 to the surrounding water 200 provided by each of the tubes A and B. With the lower efficiency heat exchanger tubes B providing a lower efficiency in comparison to the efficiency provided by the higher efficiency heat exchanger tubes A.

According to one exemplary embodiment, the higher efficiency heat exchanger tubes A are between 5% and 85% more efficient than the lower efficiency heat exchanger tubes B. According to a further exemplary embodiment, the higher efficiency heat exchanger tubes A are between 25% and 50% more efficient than the lower efficiency heat exchanger tubes B.

In a simplest embodiment, both types of tubes A and B are provided with a smooth sidewall, but the higher efficiency heat exchanger tubes A are provided with a smaller cross-sectional diameter than the lower efficiency heat exchanger tubes B. In another exemplary embodiment, the lower efficiency heat exchanger tubes B are provided with a thicker sidewall than that of the higher efficiency heat exchanger tubes A, or made from a material with a lower thermal conductivity. In a further exemplary embodiment, the lower efficiency heat exchanger tubes B are provided with a smooth sidewall while the higher efficiency heat exchanger tubes A are provided with a corrugated sidewall. In still another exemplary embodiment, each of the tubes A and B are provided with corrugations but the lower efficiency heat exchanger tubes B are provided with fewer or less efficient corrugations.

In the exemplary embodiment shown in FIGS. 3 and 4, the lower efficiency heat exchanger tubes B have a diameter that is larger than the diameter of the higher efficiency heat exchanger tubes A. In addition, the lower efficiency heat exchanger tubes B are spaced apart and each of the lower efficiency heat exchanger tubes B is surrounded by the higher efficiency heat exchanger tubes A.

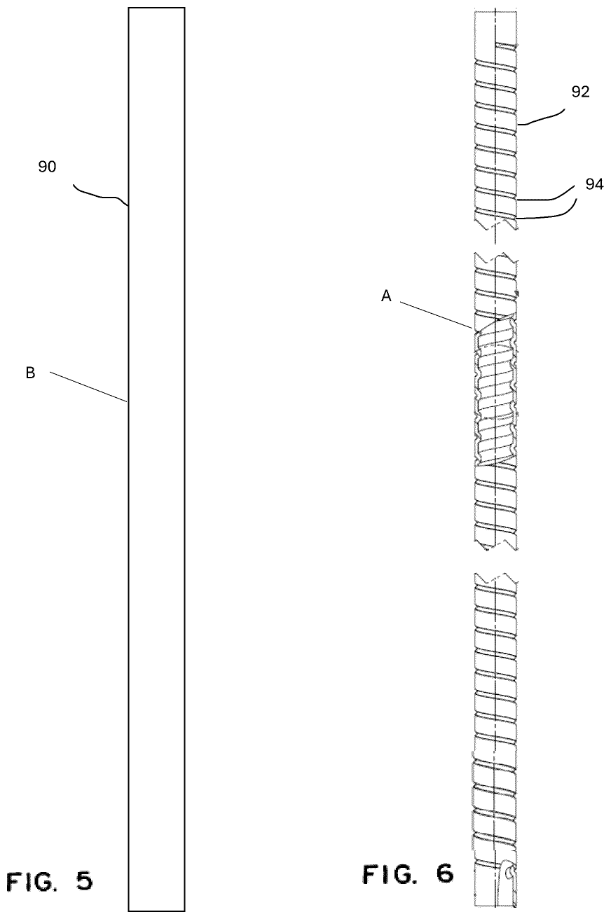

FIG. 5 shows an exemplary embodiment of the low efficiency heat exchanger tube B wherein the tube is provided with a smooth side wall 90. FIG. 6 illustrates a higher efficiency heat exchanger tube A, according to an exemplary embodiment, wherein the tube is provided with a side wall 92 having corrugations 94. Alternative side wall structures can include dimples, ridges, bumps, edges, fins, extrusions, inserted turbulators or flow mixing devices, or other features configured to disrupt the smooth flow of combustion gas resulting in increased heat transfer.

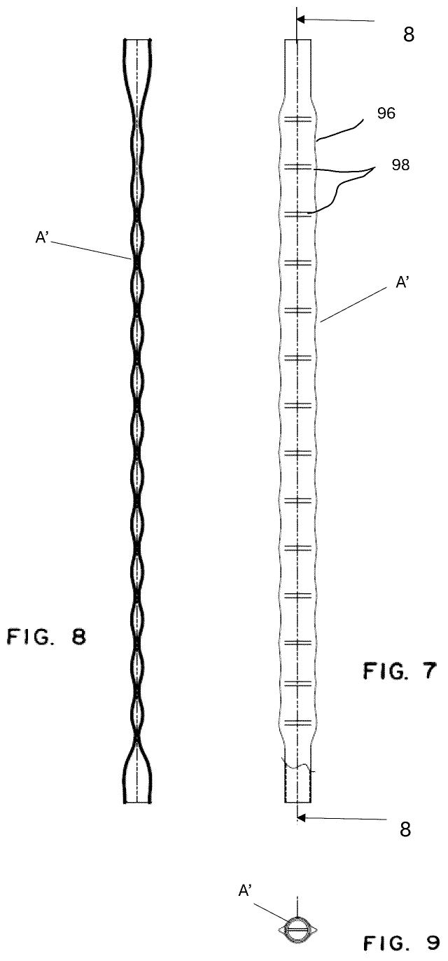

FIGS. 7-9 illustrate a higher efficiency heat exchanger tube A′, according to a further exemplary embodiment wherein the side wall 96 of the tube A′ is flattened and provided with uniformly spaced crimps 98 along a length of the tube A′.

Embodiments of the heat exchanger tubes 16 according to the present invention can be prepared in various lengths and diameters configured to accommodate the heat exchanger 10. In an embodiment, lower efficiency heat exchanger tubes can be prepared in a larger or smaller diameter to assist with construction. Specifically, the different diameters can assist with selecting the appropriate heat exchanger tube for each sector of the heat exchanger. Alternatively, the heat exchanger tubes can have approximately equal diameters.

As described hereinabove, combustion gas exiting the condensing boiler at temperatures at or about approximately 360° F., are now relatively dry and are suitable to be vented into a non-condensing stack. Considerable electrical energy savings is achieved by removing the water vapor without the need for subsequent heating the flue gas. This improvement allows the flue gas to achieve at least 360° F. with considerably less energy than would have been required under conventional systems, e.g., systems that heat the flue gas plus the water in the flue gas.

The use of a mixture of lower efficiency heat exchanger tubes and higher efficiency heat exchanger tubes has been surprisingly found to remove vapor from the combustion gas, and simultaneously allow for a relatively high temperature flue gas. It has been found that flue gas temperatures at or above 360° F. provide adequate updraft in non-condensing stacks venting flue gas from the condensing boilers.

The heat exchanger and heat exchanger tubes of the present invention can be prepared from high grade metals. In a preferred embodiment the heat exchanger and heat exchanger tubes are prepared from stainless steel. Alternative materials can include titanium,

Alloy steel, aluminum, copper, bronze, carbon fiber, or any of the above with protective coating, shield, or surface treatment, and combinations thereof.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A condensing boiler comprising:
a heat exchanger configured to be fluidly coupled to burner, a hot water supply, and a cold water supply, the heat exchanger including,
multiple lower efficiency heat exchanger tubes, and
multiple higher efficiency heat exchanger tubes,
wherein each of the lower efficiency heat exchanger tubes are encircled by at least three of the higher efficiency heat exchanger tubes.

2. A condensing boiler according to claim 1, wherein:
the lower efficiency heat exchanger tubes have a smooth sidewall; and
the higher efficiency heat exchanger tubes have a corrugated sidewall.

3. A condensing boiler according to claim 1, wherein:
the lower efficiency heat exchanger tubes have a smooth sidewall; and
the higher efficiency heat exchanger tubes have a flattened sidewall with crimped portions.

4. A condensing boiler according to claim 3, wherein the lower efficiency heat exchanger tubes have a larger cross-sectional diameter than the higher efficiency heat exchanger tubes.

5. A condensing boiler according to claim 1, wherein the lower efficiency heat exchanger tubes have a smaller cross-sectional diameter than the higher efficiency heat exchanger tubes.

6. A condensing boiler according to claim 1, wherein a ratio between the higher efficiency heat exchanger tubes and the lower efficiency heat exchanger tubes is between 1:100 to 1:10

7. A condensing boiler according to claim 1, wherein a ratio between the higher efficiency heat exchanger tubes and the lower efficiency heat exchanger tubes is between 1:10 to 1:5.

8. A condensing boiler according to claim 1, wherein a ratio between the higher efficiency heat exchanger tubes and the lower efficiency heat exchanger tubes is between 1:20 to 1:2.

9. A condensing boiler according to claim 1, wherein a ratio between the higher efficiency heat exchanger tubes and the lower efficiency heat exchanger tubes is between about 50% and about 99%.

10. A condensing boiler according to claim 1, wherein a ratio between the higher efficiency heat exchanger tubes and the lower efficiency heat exchanger tubes is between about 65% and about 98%.

11. A condensing boiler according to claim 1, wherein a ratio between the higher efficiency heat exchanger tubes and the lower efficiency heat exchanger tubes is between about 75% and about 95%.

12. A condensing boiler according to claim 1, wherein the higher efficiency heat exchanger tubes are between about 5% and 85% more efficient than the lower efficiency heat exchanger tubes.

13. A condensing boiler according to claim 1, wherein the higher efficiency heat exchanger tubes are between about 25% and 50% more efficient than the lower efficiency heat exchanger tubes.

14. A method to vent a condensing boiler into a non-condensing stack comprising:
providing a condensing boiler having a heat exchanger;
passing combustion gas through a mixture of higher efficiency heat exchanger tubes and lower efficiency heat exchanger tubes in the heat exchanger, wherein each of the lower efficiency heat exchanger tubes are encircled by at least three of the higher efficiency heat exchanger tubes in the heat exchanger; and
venting the combustion gases from the heat exchanger into the non-condensing stack.

15. A method according to claim 14, wherein:
the lower efficiency heat exchanger tubes are provided with a smooth sidewall; and
the higher efficiency heat exchanger tubes are provided with a corrugated sidewall.

16. A method according to claim 14, wherein:
the lower efficiency heat exchanger tubes are provided with a smooth sidewall; and
the higher efficiency heat exchanger tubes are provided with a flattened sidewall with crimped portions.

17. A method according to claim 16, wherein the lower efficiency heat exchanger tubes have a larger cross-sectional diameter than the higher efficiency heat exchanger tubes.

18. A method according to claim 14, wherein the lower efficiency heat exchanger tubes are provided with a smaller cross-sectional diameter than the higher efficiency heat exchanger tubes.

19. A method according to claim 14, wherein a ratio between the higher efficiency heat exchanger tubes and the lower efficiency heat exchanger tubes is between 1:100 to 1:10.

20. A method according to claim 14, wherein a ratio between the higher efficiency heat exchanger tubes and the lower efficiency heat exchanger tubes is between 1:10 to 1:5.

21. A method according to claim 14, wherein a ratio between the higher efficiency heat exchanger tubes and the lower efficiency heat exchanger tubes is between 1:20 to 1:2.

22. A method according to claim 14, wherein a ratio between the higher efficiency heat exchanger tubes and the lower efficiency heat exchanger tubes is between about 50% and about 99%.

23. A method according to claim 14, wherein a ratio between the higher efficiency heat exchanger tubes and the lower efficiency heat exchanger tubes is between about 65% and about 98%.

24. A method according to claim 14, wherein a ratio between the higher efficiency heat exchanger tubes and the lower efficiency heat exchanger tubes is between about 75% and about 95%.

25. A method according to claim 14, wherein the higher efficiency heat exchanger tubes are between about 5% and 85% more efficient than the lower efficiency heat exchanger tubes.

26. A method according to claim 14, wherein the higher efficiency heat exchanger tubes are between about 25% and 50% more efficient than the lower efficiency heat exchanger tubes.
